(19) United States
(12) Patent Application Publication
(10) Pub. No.: US 2020/0308487 A1
(43) Pub. Date: Oct. 1, 2020

(54) LIQUID CRYSTAL POLYESTER COMPOSITION AND RESIN MOLDED BODY

(71) Applicant: SUMITOMO CHEMICAL COMPANY, LIMITED, Tokyo (JP)

(72) Inventor: Hiromitsu HEGI, Tsukuba-shi (JP)

(21) Appl. No.: 16/763,155

(22) PCT Filed: Nov. 14, 2018
(86) PCT No.: PCT/JP2018/042107

§ 371 Date: May 11, 2020

(30) Foreign Application Priority Data
Nov. 15, 2017 (JP) 2017-220365

(51) Int. Cl. C09K 19/38

(52) U.S. Cl. CPC C09K 19/3809

(57) ABSTRACT

A liquid crystal polyester composition including a liquid crystal polyester and fibrous fillers, wherein in the fibrous fillers, the number of long fibers having a fiber length of 80 μm or more contained in the fibrous fillers is 30% or less with respect to the number of the fibrous fillers, and a number average fiber diameter of the fibrous fillers is 12 μm or less.

### TECHNICAL FIELD

The present invention relates to a liquid crystal polyester composition and a resin molded body.

Priority is claimed on Japanese Patent Application No. 2017-220365, filed Nov. 15, 2017, the content of which is incorporated herein by reference.

### BACKGROUND ART

Liquid crystal polyesters are materials that are easy to mold and process, and have high heat resistance, high mechanical strength, or excellent insulation properties. In addition, liquid crystal polyesters have high flame retardancy. Taking advantage of these features, liquid crystal polyesters have been applied to various applications, including electric/electronic components and components for optical devices. Usually, a liquid crystal polyester is rarely used alone, and is used as a liquid crystal polyester composition in which a filler is contained in a liquid crystal polyester (LCP) in order to satisfy required characteristics (for example, flexural strength) in various applications.

Incidentally, when a molded body such as an electric/electronic component or a component for an optical device is produced using the liquid crystal polyester composition as described above, the yield in the process of assembling the electric/electronic component or the component for an optical device may be reduced due to a foreign substance generated from the molded body. In addition, when electrical and electronic equipment or optical equipment using the above-described component (molded body) is used over time, a malfunction may be caused due to a foreign substance generated from the molded body. Accordingly, a molded body in which the generation of foreign substances is suppressed has been studied.

For example, Patent Document 1 describes a liquid crystal polyester resin composition capable of preventing the generation of surface particles (foreign substances). The liquid crystal polyester resin composition described in Patent Document 1 contains 0.01 to 10 parts by weight of activated carbon, 5 to 50 parts by weight of a glass fiber, and 1 to 50 parts by weight of flaky mica with respect to 100 parts by weight of a liquid crystal polyester.

### CITATION LIST

### Patent Documents

[Patent Document 1] JP2008-239950A

### SUMMARY OF THE INVENTION

### Problems to be Solved by the Invention

However, the liquid crystal polyester resin composition described in Patent Document 1 cannot necessarily suppress the generation of foreign substances, and further improvement has been required.

The present invention has been made in view of such circumstances, with an object of providing a liquid crystal polyester composition and a resin molded body in which the generation of foreign substances is suppressed.

### Means to Solve the Problems

In order to solve the above problems, one aspect of the present invention provides a liquid crystal polyester composition including a liquid crystal polyester and fibrous fillers, wherein the fibrous fillers contain 30% or less of a long fiber having a fiber length of 80 μm or more with respect to the number of the fibrous fillers, and the number average fiber diameter of the fibrous fillers is 12 μm or less.

One aspect of the present invention provides a liquid crystal polyester composition, including a liquid crystal polyester and fibrous fillers, wherein a number average fiber length of the fibrous fillers is 15 μm or more and 60 μm or less, and a number average fiber diameter of the fibrous fillers is 12 μm or less.

In one aspect of the present invention, it may be configured so that the number average fiber diameter of the fibrous fillers is 6 μm or less.

In one aspect of the present invention, it may be configured so that a content of the fibrous fillers is 10 parts by mass or more and 150 parts by mass or less with respect to 100 parts by mass of the liquid crystal polyester.

One aspect of the present invention provides a resin molded body using the above liquid crystal polyester composition as a forming material.

That is, the present invention includes the following aspects.

[1] A liquid crystal polyester composition including a liquid crystal polyester and fibrous fillers,

wherein in the fibrous fillers, the number of long fibers having a fiber length of 80 μm or more contained in the fibrous fillers is 30% or less with respect to the number of the fibrous fillers, and

a number average fiber diameter of the fibrous fillers is 12 μm or less.

[2] A liquid crystal polyester composition including a liquid crystal polyester and fibrous fillers,

wherein a number average fiber length of the fibrous fillers is 15 μm or more and 60 μm or less, and

a number average fiber diameter of the fibrous fillers is 12 μm or less.

[3] The liquid crystal polyester composition according to [1] or [2], wherein the number average fiber diameter of the fibrous fillers is 6 μm or less.

[4] The liquid crystal polyester composition according to any one of [1] to [3], wherein a content of the fibrous fillers is 10 parts by mass or more and 150 parts by mass or less with respect to 100 parts by mass of the liquid crystal polyester.

[5] A resin molded body formed from the liquid crystal polyester composition according to any one of [1] to [4].

### Effects of the Invention

According to one aspect of the present invention, there are provided a liquid crystal polyester composition and a resin molded body in which the generation of foreign substances is suppressed.

In the present specification, the term “foreign substance” is a component derived from the liquid crystal polyester composition which is generated at the time of assembling or using electrical and electronic equipment or optical equipment using a resin molded body formed from the liquid crystal polyester composition as a component. For example, the term means a fibrous filler, a liquid crystal polyester resin, or a mixture thereof.

### EMBODIMENTS FOR CARRYING OUT THE INVENTION

A liquid crystal polyester composition of the present embodiment is used as a material for forming a resin molded body described later. The liquid crystal polyester composition of the present embodiment includes a liquid crystal polyester and a fibrous filler.

It should be noted that in the present specification, a mixture obtained by mixing a liquid crystal polyester and a fibrous filler is referred to as a “composition”. In addition, a material obtained by forming the obtained mixture into a pellet is also referred to as a “composition” in the same manner.

### [Liquid Crystal Polyester]

The liquid crystal polyester according to the liquid crystal polyester composition of the present embodiment is a material exhibiting liquid crystallinity in a molten state. The liquid crystal polyester may be a liquid crystal polyester amide, a liquid crystal polyester ether, a liquid crystal polyester carbonate, or a liquid crystal polyester imide.

The flow starting temperature of the liquid crystal polyester according to the present embodiment is preferably 330° C. or higher. The flow starting temperature of the liquid crystal polyester is more preferably 330° C. or higher and 450° C. or lower, still more preferably 330° C. or higher and 400° C. or lower, and particularly preferably 330° C. or higher and 390° C. or lower. Further, the flow starting temperature may be 340° C. or higher, 350° C. or higher, or 360° C. or higher.

In one aspect, the flow starting temperature may be 340° C. or higher and 450° C. or lower, 350° C. or higher and 400° C. or lower, or 360° C. or higher and 390° C. or lower.

The flow starting temperature is a temperature at which a viscosity of 4,800 Pa·s (48,000 poise) is exhibited when a liquid crystal polyester is melted and extruded from a nozzle having an inner diameter of 1 mm and a length of 10 mm, while raising the temperature at a rate of 4° C./min under a load of 9.8 MPa (100 kg/cm′) using a capillary rheometer, which serves as an indicator of the molecular weight of the liquid crystal polyester (see “Liquid Crystal Polymer—Synthesis, Molding, and Application—” edited by Naoyuki Koide, p. 95, CMC Publishing Co., Ltd., published on Jun. 5, 1987).

The liquid crystal polyester according to the present embodiment is preferably a wholly aromatic liquid crystal polyester in which only an aromatic compound is polymerized as a raw material monomer.

Typical examples of the liquid crystal polyester according to the present embodiment include those obtained by polymerization (polycondensation) of at least one compound selected from the group consisting of an aromatic diol, an aromatic hydroxylamine and an aromatic diamine, an aromatic hydroxycarboxylic acid, and an aromatic dicarboxylic acid; those obtained by polymerization of a plurality of types of aromatic hydroxycarboxylic acids; those obtained by polymerization of at least one compound selected from the group consisting of an aromatic hydroxylamine and an aromatic diamine, an aromatic dicarboxylic acid, and an aromatic diol; and those obtained by polymerization of a polyester such as polyethylene terephthalate and an aromatic hydroxycarboxylic acid.

Here, the aromatic hydroxycarboxylic acid, the aromatic dicarboxylic acid, the aromatic diol, the aromatic hydroxylamine and the aromatic diamine may be each independently replaced partially or entirely with a polymerizable derivative thereof.

Examples of the polymerizable derivative of a compound having a carboxyl group such as an aromatic hydroxycarboxylic acid and an aromatic dicarboxylic acid include those in which a carboxyl group is substituted with an alkoxycarbonyl group or an aryloxycarbonyl group (that is, an ester), those in which a carboxyl group is substituted with a haloformyl group (that is, an acid halide), and those in which a carboxyl group is substituted with an acyloxycarbonyl group (that is, an acid anhydride).

Examples of the polymerizable derivative of a compound having a hydroxyl group such as an aromatic hydroxycarboxylic acid, an aromatic diol and an aromatic hydroxylamine include those in which a hydroxyl group is acylated and substituted with an acyloxyl group (that is, an acylated product of hydroxyl group).

Examples of the polymerizable derivative of a compound having an amino group such as an aromatic hydroxylamine and an aromatic diamine include those in which an amino group is acylated and substituted with an acylamino group (that is, an acylated product of amino group).

The liquid crystal polyester according to the present embodiment preferably has a repeating unit represented by the following formula (1) (hereinafter may be referred to as “repeating unit (1)” in some cases), and more preferably has the repeating unit (1), a repeating unit represented by the following formula (2) (hereinafter may be referred to as “repeating unit (2)” in some cases) and a repeating unit represented by the following formula (3) (hereinafter may be referred to as “repeating unit (3)” in some cases).

—O—Ar¹—CO— (1)

—CO—Ar²—CO— (2)

—X—Ar³—Y— (3)

In the above formulas (1) to (3), Ar¹ represents a phenylene group, a naphthylene group or a biphenylylene group. Ar² and Ar³ each independently represent a phenylene group, a naphthylene group, a biphenylylene group or a group represented by the following formula (4). X and Y each independently represent an oxygen atom or an imino group (—NH—). Hydrogen atoms in the group represented by Ar¹, Ar² or Ar³ may be each independently substituted with a halogen atom, an alkyl group or an aryl group.

—Ar⁴—Z—Ar⁵— (4)

In the formula (4), Ar⁴ and Ar⁵ each independently represent a phenylene group or a naphthylene group. Z represents an oxygen atom, a sulfur atom, a carbonyl group, a sulfonyl group or an alkylidene group.

Hydrogen atoms contained in the group represented by Ar⁴ or Ar⁵ may be each independently substituted with a halogen atom, an alkyl group or an aryl group.

Examples of the halogen atom which can be substituted with a hydrogen atom include a fluorine atom, a chlorine atom, a bromine atom and an iodine atom.

The alkyl group which can be substituted with a hydrogen atom is preferably an alkyl group having 1 to 10 carbon atoms, and examples thereof include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group and an n-decyl group.

As examples of the aryl group which can be substituted with a hydrogen atom, aryl groups in which at least one of the hydrogen atoms constituting the aryl group may be substituted, and a total number of carbon atoms including those of the substituent is 6 to 20 are preferable, and examples thereof include a phenyl group, an o-tolyl group, an m-tolyl group, a p-tolyl group, a 1-naphthyl group and a 2-naphthyl group.

When the hydrogen atom in the group represented by Ar¹, Ar² or Ar³ is substituted with these groups, the number of substitutions is usually 2 or less and preferably 1, independently for each of the groups represented by Ar¹, Ar² or Ar³.

The alkylidene group is preferably an alkylidene group having 1 to 10 carbon atoms, and examples thereof include a methylene group, an ethylidene group, an isopropylidene group, an n-butylidene group and a 2-ethylhexylidene group.

The repeating unit (1) is a repeating unit derived from a predetermined aromatic hydroxycarboxylic acid. As the repeating unit (1), those in which Ar¹ is a p-phenylene group (for example, a repeating unit derived from p-hydroxybenzoic acid) and those in which Ar¹ is a 2,6-naphthylene group (for example, a repeating unit derived from 6-hydroxy-2-naphthoic acid) are preferable.

It should be noted that in the present specification, the expression “derived” means that the chemical structure is changed due to polymerization of raw material monomers, while no other structural change occurs.

The repeating unit (2) is a repeating unit derived from a predetermined aromatic dicarboxylic acid. As the repeating unit (2), those in which Ar² is a p-phenylene group (for example, a repeating unit derived from terephthalic acid), those in which Ar² is a m-phenylene group (for example, a repeating unit derived from isophthalic acid), those in which Ar² is a 2,6-naphthylene group (for example, a repeating unit derived from 2,6-naphthalenedicarboxylic acid), and those in which Ar² is a diphenylether-4,4′-diyl group (for example, a repeating unit derived from diphenyl ether-4,4′-dicarboxylic acid) are preferable.

The repeating unit (3) is a repeating unit derived from a predetermined aromatic diol, aromatic hydroxylamine or aromatic diamine. As the repeating unit (3), those in which Ar³ is a p-phenylene group (for example, a repeating unit derived from hydroquinone, p-aminophenol or p-phenylenediamine), and those in which Ar³ is a 4,4′-biphenylylene group (for example, a repeating unit derived from 4,4′-dihydroxybiphenyl, 4-amino-4′-hydroxybiphenyl or 4,4′-diaminobiphenyl) are preferable.

The content of the repeating unit (1) in the liquid crystal polyester is usually 30 mol % or more, preferably from 30 to 80 mol %, more preferably from 40 to 70 mol %, and still more preferably from 45 to 65 mol %, with respect to the total amount of all the repeating units constituting the liquid crystal polyester.

The total amount of all the repeating units constituting the liquid crystal polyester is a value obtained by dividing the mass of each repeating unit constituting the liquid crystal polyester by the formula weight of each repeating unit, determining the equivalents (mol) of the amounts of substances of each repeating unit and summing them up. The mass of each repeating unit constituting the liquid crystal polyester is calculated from the amount of the raw material monomer used, which is a numerical value when it is assumed that all the raw material monomers react.

Similarly, the content of the repeating unit (2) in the liquid crystal polyester is usually 35 mol % or less, preferably from 10 to 35 mol %, more preferably from 15 to 30 mol %, and still more preferably from 17.5 to 27.5 mol %, with respect to the total amount of all the repeating units constituting the liquid crystal polyester.

The content of the repeating unit (3) in the liquid crystal polyester is usually 35 mol % or less, preferably from 10 to 35 mol %, more preferably from 15 to 30 mol %, and still more preferably from 17.5 to 27.5 mol %, with respect to the total amount of all the repeating units constituting the liquid crystal polyester.

The higher the content of the repeating unit (1) in the liquid crystal polyester, the easier the melt fluidity, heat resistance and strength/rigidity are improved. However, when the content of the repeating unit (1) is more than 80 mol %, the melt temperature and melt viscosity tend to be high, and the temperature required for molding tends to be high.

In the liquid crystal polyester of the present embodiment, the ratio of the content of the repeating unit (2) to the content of the repeating unit (3) is calculated from the formula represented by: [content of the repeating unit (2)]/[content of the repeating unit (3)] (mol %/mol %). The ratio of the content of the repeating unit (2) to the content of the repeating unit (3) is usually from 0.9 to 1.11, preferably from 0.95 to 1.05, and more preferably from 0.98 to 1.02.

It should be noted that the repeating units (1) to (3) contained included in the liquid crystal polyester may be each independently derived from one type of raw material monomer, or may be derived from two or more types of raw material monomers. Further, the liquid crystal polyester may have a repeating unit other than the repeating units (1) to (3). The content of the repeating unit other than the repeating units (1) to (3) is usually 0 mol % or more and 10 mol % or less, and preferably 0 mol % or more and 5 mol % or less, with respect to the total amount of all the repeating units constituting the liquid crystal polyester.

The liquid crystal polyester preferably has a repeating unit (3) in which X and Y each represent an oxygen atom. That is, it is preferable to have a repeating unit derived from a predetermined aromatic diol because the melt viscosity tends to be low. Further, it is more preferable to include only those in which X and Y each represent an oxygen atom as the repeating unit (3).

The liquid crystal polyester according to the method for producing a liquid crystal polyester composition of the present embodiment may be commercially available or may be synthesized from a raw material monomer corresponding to a repeating unit constituting the liquid crystal polyester.

In the case of synthesizing a liquid crystal polyester, it is preferably produced by melt polymerization of a raw material monomer and solid phase polymerization of the obtained polymer (hereinafter, sometimes referred to as “prepolymer”). As a result, for example, a liquid crystal polyester having a high flow starting temperature of 330° C. or higher can be produced with favorable operability.

The melt polymerization may be carried out in the presence of a catalyst. Examples of the catalyst that may be used in the melt polymerization include metal compounds such as magnesium acetate, stannous acetate, tetrabutyl titanate, lead acetate, sodium acetate, potassium acetate and antimony trioxide, and nitrogen-containing heterocyclic compounds such as 4-(dimethylamino)pyridine and 1-methylimidazole, and nitrogen-containing heterocyclic compounds are preferably used.

The liquid crystal polyesters are those having the same repeating units within the above range, and those with different repeating unit contents may be used in combination.

### [Fibrous Filler]

As a material constituting the fibrous filler according to the present embodiment, an inorganic substance is preferable from the viewpoint of obtaining a resin molded body having higher strength. More specifically, examples of the fibrous filler according to the present embodiment include glass fibers, ceramic fibers, PAN-based carbon fibers, pitch-based carbon fibers, alumina fibers, silica fibers, and silica alumina fibers. Among them, glass fibers are more preferable as the fibrous filler because of low wear load applied to the apparatus during molding and ease of availability. It should be noted that the fibrous filler according to the present embodiment does not include a whisker filler. In general, a whisker refers to a beard-like single crystal fiber formed by crystal growth.

The number average fiber diameter of the fibrous filler in the liquid crystal polyester composition of the present embodiment is 12 μm or less, and the number average fiber length of the fibrous filler is 15 μm or more and 60 μm or less. By satisfying these conditions, the resin molded body formed from the liquid crystal polyester composition of the present embodiment can suppress the generation of foreign substances during assembly or use.

In one aspect, the number average fiber length of the fibrous filler may be 26 μm or more and 59 μm or less.

Furthermore, in order to further suppress the generation of foreign substances during assembly or use, the number average fiber diameter of the above fibrous filler is preferably 11 μm or less. Further, the number average fiber diameter of the above fibrous filler is more preferably 6 μm or less, and still more preferably 5 μm or less. When the number average fiber diameter of the above fibrous filler is 5 μm or less, the strength of the resin molded body improves, although the cause is unknown. The lower limit of the number average fiber diameter of the above fibrous filler is not limited, but is practically 2 μm or more for the sake of melt-kneading during the production of the liquid crystal polyester composition.

In one aspect, the number average fiber diameter of the above fibrous filler is 2 μm or more and 12 μm or less, preferably 2 μm or more and 11 μm or less, more preferably 2 μm or more and 6 μm or less, and still more preferably 2 μm or more and 5 μm or less.

From another viewpoint, the fibrous fillers in the liquid crystal polyester composition of the present embodiment are such that the number of long fibers having a fiber length of 80 μm or more contained in the fibrous fillers is 0% or more and 30% or less with respect to the number of the fibrous fillers. When the content of the long fibers in the liquid crystal polyester composition of the present embodiment is 0% or more and 30% or less, it is possible to form a resin molded body in which the generation of foreign substances is suppressed.

In addition, in order to obtain a resin molded body that can further suppress the generation of foreign substances during assembly or use, the content of the long fibers is preferably 0% or more and 25% or less with respect to the number of the fibrous fillers. In another aspect, the content of the long fibers may be 0% or more and 22% or less, or 1% or more and 11% or less with respect to the number of the fibrous fillers.

In the present specification, the number average fiber diameter and the number average fiber length of the fibrous fillers in the liquid crystal polyester composition, and the ratio (content) of the long fibers with respect to the number of the fibrous fillers can be determined from a micrograph of the fibrous fillers included in the liquid crystal polyester composition.

These measurement methods will be described more specifically. It should be noted that in the following measurement methods, the number of observations made (the number of fibrous fillers) in a micrograph is 400.

First, the liquid crystal polyester composition is incinerated at 600° C. or higher. Next, the obtained residue is dispersed in methanol, and while being spread on a slide glass, a micrograph is taken at a magnification of 100 times. Then, the length (fiber length) of the fibrous filler is read from the obtained photograph, and the average value of the number of fibrous fillers (400) is calculated, whereby the number average fiber length of the fibrous fillers can be determined.

The number average fiber diameter of the fibrous fillers can be determined by taking a micrograph at a magnification of 500 times, reading the fiber diameters of the fibrous fillers from the obtained photograph, and calculating the average value for the number of fibrous fillers (400).

The content of the long fibers having a fiber length of 80 μm or more can be calculated by dividing the number of the long fibers having a fiber length of 80 μm or more by the number of fibrous fillers (400) using the measured value of the fiber length obtained in the above measurement.

It should be noted that the term “fiber length” means the maximum length of the fibrous filler.

The term “fiber diameter” means, for example, the maximum diameter (length) in a direction orthogonal to the length direction of the fibrous filler.

The upper limit of the length of the long fibers contained in the fibrous filler is usually 1,000 μm or less.

Further, the fibrous fillers according to the present embodiment are preferably not subjected to a surface coating treatment. As a result, it is possible to prevent the generation of gas from the surface coating agent adhered to the fibrous filler of the obtained resin molded body, and to improve the chemical stability of the resin molded body. Further, at the time of assembling the resin molded body, the gas generated from the resin molded body is unlikely to contaminate peripheral members. In the present embodiment, examples of the surface coating treatment includes a surface coating treatment with a coupling agent such as a silane coupling agent or a titanium coupling agent, and a surface coating treatment with a thermoplastic resin or thermosetting resin other than the liquid crystal polyester.

The liquid crystal polyester composition of the present embodiment preferably contains fibrous fillers in an amount of 10 parts by mass or more and 150 parts by mass or less with respect to 100 parts by mass of the liquid crystal polyester. When the amount of the fibrous fillers exceeds 150 parts by mass, foreign substances tend to be easily generated in the obtained resin molded body during assembly or use. On the other hand, when the amount of the fibrous fillers is less than 10 parts by mass, there is a tendency that the dimensional stability of the obtained resin molded body is reduced and a resin molded body having a desired size is unlikely to be obtained. Further, when the amount of the fibrous fillers is less than 10 parts by mass, the anisotropy of the liquid crystal polyester is strongly exhibited, and warpage may occur in the resin molded body. Furthermore, when the amount of the fibrous fillers is small, the effect of improving the mechanical strength may be reduced.

The content of the fibrous fillers in the liquid crystal polyester composition of the present embodiment is more preferably 15 parts by mass or more, still more preferably 20 parts by mass or more, particularly preferably 25 parts by mass or more, and most preferably 30 parts by mass or more with respect to 100 parts by mass of the liquid crystal polyester in consideration of the balance of properties such as the above-described generation of foreign substances in the resin molded body, dimensional stability, warpage, and mechanical strength. In addition, the content of the fibrous fillers in the liquid crystal polyester composition of the present embodiment is more preferably 140 parts by mass or less, and still more preferably 70 parts by mass or less with respect to 100 parts by mass of the liquid crystal polyester.

In one aspect, the content of the fibrous fillers in the liquid crystal polyester composition of the present embodiment is preferably 15 parts by mass or more and 140 parts by mass or less, more preferably 20 parts by mass or more and 140 parts by mass or less, still more preferably 20 parts by mass or more and 70 parts by mass or less, particularly preferably 25 parts by mass or more and 70 parts by mass or less, and most preferably 30 parts by mass or more and 70 parts by mass or less with respect to 100 parts by mass of the liquid crystal polyester.

In one aspect, the content of the liquid crystal polyester in the liquid crystal polyester composition of the present embodiment is preferably from 42 to 87% by mass with respect to the total mass of the liquid crystal polyester composition.

In one aspect, the content of the fibrous fillers in the liquid crystal polyester composition of the present embodiment is preferably from 13 to 58% by mass with respect to the total mass of the liquid crystal polyester composition.

The liquid crystal polyester composition of the present embodiment may contain other components (such as additives) as long as the effects of the present invention are not impaired. Examples of such additives include plate-like fillers, coloring components, lubricants, and stabilizers.

In one aspect, the content of the other components is preferably from 0.0001 to 5 parts by mass with respect to 100 parts by mass of the liquid crystal polyester.

In another aspect, the content of the other components in the liquid crystal polyester composition of the present embodiment is preferably from 0.01 to 5% by mass with respect to the total mass of the liquid crystal polyester composition.

### <Production Method of Liquid Crystal Polyester Composition>

In order to obtain the resin molded body of the present embodiment, it is preferable that a liquid crystal polyester and fibrous fillers are melt-kneaded in advance to produce a pellet-shaped liquid crystal polyester composition (hereinafter, sometimes referred to as “composition”). It should be noted that when the above-described additives and the like other than the liquid crystal polyester and the fibrous fillers are used, the composition may be formed by melt-kneading the additives and the like together with the liquid crystal polyester and the fibrous fillers.

### <Resin Molded Body>

The resin molded body of the present embodiment uses the above-mentioned liquid crystal polyester composition as a forming material. According to the resin molded body of the present embodiment, generation of foreign substances during assembly or use of the resin molded body (that is, at the time of assembling or using electrical and electronic equipment or optical equipment using the resin molded body as a component) can be suppressed. The effect of suppressing the generation of foreign substances as described above can be confirmed by the following test.

First, after drying the composition, injection molding is performed using an injection molding machine (model PS40E-SASE manufactured by Nissei Plastic Industrial Co., Ltd.) under the molding conditions of a cylinder temperature of 350° C., a mold temperature of 130° C., and an injection speed of 60% to obtain a test piece (resin molded body) having a length of 64 mm, a width of 64 mm, and a thickness of 1 mm. It should be noted that a 64 mm×1 mm film gate is provided at an end of a cavity of a mold used for injection molding.

An operation is carried out in which a tape (Cellotape (registered trademark) No. 405, manufactured by Nichiban Co., Ltd.) is adhered to the upper surface portion of the test piece along the flow direction of the liquid crystal polyester in the test piece over the entire length of the test piece, and is then quickly peeled off from one end of the tape towards the other end along the flow direction. This operation is defined as one cycle, and a tape peeling test is carried out in which a total of 20 cycles is repeated.

Next, the surface roughness Sa of a place in the test piece where the above test is performed is measured using a 3D shape measuring machine (“VR3000” manufactured by Keyence Corporation).

The surface roughness Sa of the resin molded body of the present embodiment is preferably 0 μm or more and 0.55 μm or less, and more preferably 0.50 μm or less. When the surface roughness Sa of the resin molded body of the present embodiment is 0.55 μm or less, the resin molded body can suppress the generation of foreign substances during assembly or production.

In such a test, the surface of the resin molded body is roughened and falling off of the fibrous fillers is promoted by repeatedly peeling off the tape from the resin molded body. That is, the above tape peeling test can be considered as an accelerated test for generating foreign substances from the resin molded body.

Especially, when the number average fiber diameter of the fibrous fillers according to the present embodiment is 2 μm or more and 6 μm or less, the Izod impact strength of the resin molded body can be improved.

In the present specification, the Izod impact strength of a resin molded body is measured as follows. First, after drying the composition, injection molding is performed using an injection molding machine (model PS40E-SASE manufactured by Nissei Plastic Industrial Co., Ltd.) under the molding conditions of a cylinder temperature of 350° C., a mold temperature of 130° C., and an injection speed of 60% to obtain a test piece having a length of 64 mm, a width of 12.7 mm, and a thickness of 6.4 mm.

Next, the Izod impact strength of the obtained test piece is measured in accordance with ASTM D256.

### <Production Method of Resin Molded Body>

A composition obtained by the above method is injection molded to obtain a resin molded body.

First, the flow starting temperature FT (° C.) of the composition to be used is determined. Examples of suitable injection molding methods in order to suppress the generation of foreign substances in the resin molded body include a method in which the composition is melted at a temperature, with respect to the flow starting temperature FT (° C.) of the composition, of [FT+30]° C. or more and [FT+80]° C. or less, and injection molded into a mold set at a temperature of 80° C. or higher. It should be noted that the composition is preferably dried before injection molding.

When the above composition is injection molded at a resin melting temperature of [FT+30]° C. or higher, there is a tendency that the surface strength of the obtained resin molded body improves, and the generation of foreign substances is suppressed. Furthermore, when the above composition is injection molded at a resin melting temperature of [FT+30]° C. or higher, the fluidity of the resin at the time of molding the composition improves.

On the other hand, when injection molding is performed at a resin melting temperature of [FT+80]° C. or lower, the liquid crystal polyester remaining inside the molding machine is less susceptible to decomposition. As a result, the obtained resin molded body is less likely to generate gas and the like, and can be applied to applications such as electrical and electronic components and optical components. Further, when injection molding is performed at a resin melting temperature of [FT+80]° C. or lower, the molten resin is less likely to flow out of the nozzle when the mold is opened and the resin molded body is taken out after the injection molding. As a result, there is no need to deal with the outflow of the molten resin, and the productivity of the resin molded body improves.

It is more preferable to perform injection molding at a resin melting temperature of [FT+30]° C. or more and [FT+60]° C. or less, since the resin molded body can be stably molded.

On the other hand, the temperature of the mold to be used is preferably 80° C. or higher. When the mold temperature is 80° C. or higher, there is a tendency that the surface of the obtained resin molded body is smooth, and the amount of foreign substances generated is suppressed.

It should be noted that from the viewpoint of reducing the amount of foreign substances generated, the higher the temperature of the mold to be used, the better. However, if it is too high, the cooling effect is reduced, and the time required for the cooling step becomes longer. As a result, problems may arise, such as a reduction in the productivity of the resin molded body, and deformation of the resin molded body due to the difficulty in releasing the resin molded body after molding. Furthermore, if the temperature of the mold to be used is too high, the engagement between the molds becomes poor, and the resin molded body may be damaged when the mold is opened or closed.

Therefore, it is preferable to appropriately optimize the upper limit of the temperature of the mold to be used in accordance with the type of the composition to be used. As a result, it is possible to suppress the decomposition of the liquid crystal polyester contained in the composition.

It should be noted that as described above, when the liquid crystal polyester used in the production method of the present embodiment is a wholly aromatic liquid crystal polyester which is a particularly suitable liquid crystal polyester, the temperature of the mold to be used is preferably 100° C. or higher and 220° C. or lower, and more preferably 130° C. or higher and 200° C. or lower.

In order to determine more practical injection molding conditions for the above composition, it is preferable to carry out various preliminary experiments by changing the molding conditions. More specifically, the injection molding conditions can be optimized as follows by conducting a preliminary experiment of a series of operations, such as performing a tape peeling test using a test piece used for the above-described tape peeling test as a standard molded body, and obtaining the surface roughness Sa of the standard molded body after the test.

To give an example, first, the composition is melted and injection molded into a mold set at 80° C. to produce a standard molded body. At this time, the resin melting temperature is set in a range from [FT+40] to [FT+50]° C. which is approximately the central value of a suitable resin melting temperature with respect to the flow starting temperature FT (° C.) determined in advance. Next, a tape peeling test is performed on the obtained standard molded body to determine the surface roughness Sa of the standard molded body after the test. Subsequently, the temperature of the mold to be used is gradually raised to form each standard molded body, and the surface roughness Sa of the standard molded body after the test is determined in the same manner. Furthermore, if the surface roughness Sa of the standard molded body after the test is determined in the same manner by sequentially lowering the resin melting temperature, each of the mold temperature and the resin melting temperature can be optimized.

In addition, if the obtained standard molded body is subjected to measurement of mechanical strength such as weld strength in addition to the above tape peeling test, it is also possible to determine more suitable injection molding conditions for the above composition.

It should be noted that the injection speed of the above composition may be set in various suitable ranges depending on the molding machine used, but is preferably 50 mm/sec or more. It is preferable that the injection speed of the above composition be higher, because the productivity of the resin molded body can be increased, and the injection speed is more preferably 100 mm/sec or more, and still more preferably 200 mm/sec or more.

The composition is molded by optimizing the injection molding conditions in this manner in the preliminary experiment of forming the standard molded body, and changing the mold for obtaining the standard molded body to the mold for obtaining the desired resin molded body. By doing so, it is possible to obtain a resin molded body that can further suppress the generation of foreign substances.

The resin molded body of the present embodiment can be suitably used for, for example, components for electrical and electronic equipment or optical equipment.

It should be noted that in the above-described injection molding, an example in which a preliminary experiment using a standard molded body is carried out has been described. However, it goes without saying that the molding conditions can be optimized by means such as performing a tape peeling test on a resin molded body having a desired shape, and obtaining the surface roughness Sa of the resin molded body after the test.

### <Applications of Resin Molded Bodies>

Specific examples of members to which the resin molded body of the present embodiment can be suitably applied include electrical and electronic components such as connectors, sockets, relay components, coil bobbins, optical pickups, oscillators, printed wiring boards, circuit boards, semiconductor packages, or computer-related components, semiconductor manufacturing process-related components such as IC trays or wafer carriers, home appliance components such as VTRs, TV sets, irons, air conditioners, stereos, vacuum cleaners, refrigerators, rice cookers or lighting equipment, lighting equipment components such as lamp reflectors or lamp holders, acoustic product components such as compact discs, laser discs (registered trademark) or speakers, communication equipment components such as ferrules for optical cables, telephone components, facsimile components or modems, copying machine and printing machine-related components such as separation claws or heater holders, machine components such as impellers, fan gears, gears, bearings, motor components or cases, automobile components such as mechanical components for automobiles, engine components, engine room internal components, electrical components or interior components, cooking utensils such as microwave cooking pots or heat resistant tableware, building materials such as heat insulating and soundproofing materials including flooring materials or wall materials, supporting materials (beams, columns, or the like) or roofing materials, components for aircrafts, spacecrafts and space equipment, radiation facility members such as nuclear reactors, marine facility members, cleaning jigs, optical equipment components, valves, pipes, nozzles, filters, medical equipment components, medical materials, sensor components, sanitary equipment, sporting goods and leisure goods.

As described above, the resin molded body of the present embodiment can be used for various applications. In the resin molded body of the present embodiment, the amount of foreign substances generated during assembly or use is extremely small. For this reason, when the resin molded body of the present embodiment is used for these applications, the reliability of the resin molded body improves. More specifically, the resin molded body of the present embodiment is useful for switches, relays, image sensors and various other sensors, light emitting diodes (also referred to as LEDs), and optical mechanism systems.

In one aspect, the liquid crystal polyester composition of the present embodiment is

a liquid crystal polyester composition including a liquid crystal polyester and fibrous fillers, wherein

the liquid crystal polyester is a liquid crystal polyester having a repeating unit derived from p-hydroxybenzoic acid, a repeating unit derived from terephthalic acid, and a repeating unit derived from isophthalic acid, or a liquid crystal polyester having a repeating unit derived from 6-hydroxy-2-naphthoic acid, a repeating unit derived from 2,6-naphthalenedicarboxylic acid, a repeating unit derived from terephthalic acid, and a repeating unit derived from hydroquinone;

the fibrous fillers are at least one selected from the group consisting of ceramic fibers and glass fibers, and the ceramic fibers are preferably alkaline earth silicate fibers;

a number average fiber length of the fibrous fillers is 15 μm or more and 60 μm or less, and preferably 26 μm or more and 59 μm or less;

a number average fiber diameter of the fibrous fillers is 2 μm or more and 12 μm or less, preferably 2 μm or more and 11 μm or less, more preferably 2 μm or more and 6 μm or less, and particularly preferably 2 μm or more and 5 μm or less; and

a content of long fibers having a fiber length of 80 μm or more is 0% or more and 30% or less, preferably 0% or more and 25% or less, more preferably 0% or more and 22% or less, and still more preferably 1% or more and 11% or less with respect to the number of the fibrous fillers.

Furthermore, the liquid crystal polyester composition, when a test piece is produced under the conditions described in Examples described below and the Izod impact strength is measured, the Izod impact strength of the test piece may be 250 J/m or more and 1,030 J/m or less, and preferably 700 J/m or more and 1,030 J/m or less; and

when a test piece is produced under the conditions described in Examples described below and the surface roughness Sa after the tape peeling test is measured, the surface roughness Sa of the test piece may be 0.55 μm or less, and preferably 0.50 μm or less.

### EXAMPLES

The present invention will be described below with reference to examples, but the present invention is not limited to these examples.

### <Measurement of Flow Starting Temperature of Liquid Crystal Polyester>

Using a Flowtester (“CFT-500 model” manufactured by Shimadzu Corporation), a cylinder equipped with a die including a nozzle having an inner diameter of 1 mm and a length of 10 mm was filled with about 2 g of a liquid crystal polyester, the liquid crystal polyester was melted and extruded from the nozzle while raising the temperature at a rate of 4° C./min under a load of 9.8 MPa (100 kg/cm2), and a temperature at which a viscosity of 4,800 Pa·s (48,000 poise) was exhibited was measured.

### <Production of Liquid Crystal Polyester>

### Production Example 1

994.5 g (7.2 mol) of parahydroxybenzoic acid, 446.9 g (2.4 mol) of 4,4′-dihydroxybiphenyl, 299.0 g (1.8 mol) of terephthalic acid, 99.7 g (0.6 mol) of isophthalic acid and 1,347.6 g (13.2 mol) of acetic anhydride, and 0.194 g of 1-methylimidazole as a catalyst were added to a reactor equipped with a stirrer, a torque meter, a nitrogen gas inlet tube, a thermometer and a reflux condenser. The resulting mixture was stirred at room temperature for 15 minutes and the inside of the reactor was thoroughly replaced with nitrogen gas, and then the temperature was raised while stirring. When the internal temperature reached 145° C., the resulting mixture was stirred for 1 hour while maintaining the same temperature.

Thereafter, the temperature was raised to 320° C. over 2 hours and 50 minutes while distilling off acetic acid produced as a byproduct and unreacted acetic anhydride, and the reaction was terminated at a time point where an increase in torque was observed to obtain a prepolymer.

The obtained prepolymer was cooled to room temperature and pulverized by a coarse grinder to obtain a liquid crystal polyester powder (particle diameter: about 0.1 mm to about 1 mm), and then under a nitrogen atmosphere, the temperature was raised from room temperature to 250° C. over a period of 1 hour, the temperature was raised from 250° C. to 285° C. over a period of 5 hours, and the temperature was maintained at 285° C. for 3 hours to allow a polymerization reaction to proceed in a solid layer. The flow starting temperature of the obtained liquid crystal polyester (1) was 327° C.

### Production Example 2

1,034.99 g (5.5 mol) of 6-hydroxy-2-naphthoic acid, 378.33 g (1.75 mol) of 2,6-naphthalenedicarboxilic acid, 83.07 g (0.5 mol) of terephthalic acid, 272.52 g (2.475 mol: 0.225 mol in excess with respect to the total amount of 2,6-naphthalenedicarboxylic acid and terephthalic acid) of hydroquinone, 1,226.87 g (12 mol) of acetic anhydride and 0.17 g of 1-methylimidazole as a catalyst were placed in a reactor equipped with a stirrer, a torque meter, a nitrogen gas inlet tube, a thermometer and a reflux condenser. After replacing the gas in the reactor with nitrogen gas, the resulting mixture was heated from room temperature to 145° C. over 30 minutes while stirring in a nitrogen gas stream and refluxed at 145° C. for 1 hour.

Subsequently, the temperature was raised from 145° C. to 310° C. over 3 hours and 30 minutes while distilling off acetic acid as a byproduct and unreacted acetic anhydride, and after maintaining the temperature at 310° C. for 3 hours, the contents were taken out from the reactor and cooled to room temperature.

The obtained solid was pulverized with a grinder to obtain a powdery prepolymer. The prepolymer was heated from room temperature to 250° C. over 1 hour in a nitrogen gas atmosphere, heated from 250° C. to 293° C. over 5 hours, and held at 293° C. for 5 hours to perform solid phase polymerization, followed by cooling, whereby a powdery liquid crystal polyester (2) was obtained. The flow starting temperature of the obtained liquid crystal polyester (2) was 319° C.

### <Production of Liquid Crystal Polyester Composition>

### Examples 1 to 6, Comparative Examples 1 to 11

The liquid crystal polyesters obtained in Production Examples 1 and 2 and the following components (fibrous fillers) were granulated at a cylinder temperature of 340° C. using a twin screw extruder (“PCM-30” manufactured by Ikegai Ironworks Corp.) with the compositions shown in Tables 1 to 3 to obtain pelletized compositions. It should be noted that the average fiber lengths and the number average fiber diameters of the fibrous fillers are nominal values provided by the fibrous filler manufacturers.

### (Fibrous Filler)

Filler (1): BS20/99 (manufactured by ITM Co., Ltd., alkaline earth silicate fiber alkaline earth silicate fiber, average fiber length: 20 μm, number average fiber diameter: 3 μm)

Filler (2): BS50/99 (manufactured by ITM Co., Ltd., alkaline earth silicate fiber, average fiber length: 50 μm, number average fiber diameter: 3 μm)

Filler (3): BS100/99 (manufactured by ITM Co., Ltd., alkaline earth silicate fiber, average fiber length: 100 μm, number average fiber diameter: 3 μm)

Filler (4): PF20E-001 (manufactured by Nitto Bosch Co., Ltd., glass fiber, average fiber length: 20 μm, number average fiber diameter: 11 μm)

Filler (5): EFH75-01 (manufactured by Central Glass Fiber Co., Ltd., glass fiber, average fiber length: 75 μm, number average fiber diameter: 11 μm)

Filler (6): PF40E-001 (manufactured by Nitto Bosch Co., Ltd., glass fiber, average fiber length: 40 μm, number average fiber diameter: 11 μm)

Filler (7): EFDE50-01 (manufactured by Central Glass Fiber Co., Ltd., glass fiber, average fiber length: 50 μm, number average fiber diameter: 6 μm)

Filler (8): EFH50-01 (manufactured by Central Glass Fiber Co., Ltd., glass fiber, average fiber length: 50 μm, number average fiber diameter: 11 μm)

Filler (9): EFK80-31 (manufactured by Central Glass Fiber Co., Ltd., glass fiber, average fiber length: 80 μm, number average fiber diameter: 13 μm)

In this example, it was confirmed that the number average fiber diameter of each filler did not change before and after kneading using the above extruder.

### <Analysis of Fibrous Filler in Liquid Crystal Polyester Composition>

A portion of the composition obtained by the above method was used for the analysis of the fibrous fillers contained in the pellet. It should be noted that in the following analysis, the number of observations made (the number of fibrous fillers) in a micrograph was 400.

### [Number Average Fiber Length of Fibrous Filler]

First, 1 g of the pellet was placed in a crucible and treated at 600° C. for 6 hours in an electric furnace to incinerate.

Next, the obtained residue was dispersed in methanol, and while being spread on a slide glass, a micrograph was taken at a magnification of 100 times. The lengths of the fibrous fillers were read from the obtained photograph, and the average value for the number of fibrous fillers (400) was calculated.

### [Content of Long Fiber Having a Fiber Length of 80 μm or More]

Using the measured value of the fiber length obtained in the above measurement, the content was calculated by dividing the number of long fibers having a fiber length of 80 μm or more by the number of fibrous fillers (400).

### <Surface Tape Peeling Test (Evaluation 1)>

After drying the composition obtained by the above method, injection molding was performed using an injection molding machine (model PS40E-SASE manufactured by Nissei Plastic Industrial Co., Ltd.) under the molding conditions of a cylinder temperature of 350° C., a mold temperature of 130° C., and an injection speed of 60% to obtain a test piece (resin molded body) having a length of 64 mm, a width of 64 mm, and a thickness of 1 mm. It should be noted that a 64 mm×1 mm film gate was provided at an end of a cavity of the mold used.

An operation was carried out in which a tape (Cellotape (registered trademark) No. 405, manufactured by Nichiban Co., Ltd.) was adhered to the upper surface portion of the test piece along the flow direction of the liquid crystal polyester in the test piece over the entire length of the test piece, and was then quickly peeled off from one end of the tape towards the other end along the flow direction. This operation was defined as one cycle, and a tape peeling test was carried out in which a total of 20 cycles was repeated.

Next, the surface roughness Sa of a place in the test piece where the above test was performed was measured using a 3D shape measuring machine (“VR3000” manufactured by Keyence Corporation). The results are shown in Tables 1 to 3.

### <Izod Impact Strength (Evaluation 2)>

After drying the composition obtained by the above method, injection molding was performed using an injection molding machine (model PS40E-SASE manufactured by Nissei Plastic Industrial Co., Ltd.) under the molding conditions of a cylinder temperature of 350° C., a mold temperature of 130° C., and an injection speed of 60% to obtain a test piece having a length of 64 mm, a width of 12.7 mm, and a thickness of 6.4 mm.

The Izod impact strength of the obtained test piece was measured in accordance with ASTM D256. The results are shown in Tables 1 to 3.

TABLE 1

| | | Ex. 1 | Ex. 2 | Ex. 3 | Ex. 4 |
|---|---|---|---|---|---|
| Liquid crystal polyester (1) | | 100 | 100 | 100 | 100 |
| Fibrous | Filler (1) | 42.9 | — | — | — |
| filler | Filler (2) | — | 42.9 | — | — |
| | Filler (3) | — | — | 42.9 | — |
| | Filler (4) | — | — | — | 66.7 |

| | | | | |
|---|---|---|---|---|
| Number average fiber length | 26 | 39 | 49 | 42 |
| of fibrous fillers (μm) | | | | |
| Number average fiber diameter | 3 | 3 | 3 | 11 |
| of fibrous fillers (μm) | | | | |
| Content of long fibers (%) | 1 | 5 | 9 | 7 |
| Izod impact strength (J/m) | 780 | 735 | 814 | 628 |
| Surface roughness Sa after | 0.44 | 0.48 | 0.44 | 0.40 |
| tape peeling test (μm) | | | | |

TABLE 2

| | | Comp. Ex. 1 | Comp. Ex. 2 | Comp. Ex. 3 | Comp. Ex. 4 | Comp. Ex. 5 |
|---|---|---|---|---|---|---|
| Liquid crystal polyester (1) | | 100 | 100 | 100 | 100 | — |
| Fibrous filler | Filler (5) | 66.7 | 42.9 | — | — | — |
| | Filler (6) | — | — | 66.7 | — | — |
| | Filler (7) | — | — | — | 42.9 | — |
| | Filler (8) | — | — | — | — | 42.9 |

| | | | | | |
|---|---|---|---|---|---|
| Number average fiber length of | 103 | 95 | 84 | 69 | 75 |
| fibrous fillers (μm) | | | | | |
| Number average fiber diameter | 11 | 11 | 11 | 6 | 11 |
| of fibrous fillers (μm) | | | | | |
| Content of long fibers (%) | 65 | 59 | 42 | 32 | 35 |
| Izod impact strength (J/m) | 511 | 578 | 544 | 656 | 581 |
| Surface roughness Sa after tape | 0.74 | 0.79 | 0.64 | 0.75 | 0.56 |
| peeling test (μm) | | | | | |

TABLE 3

| | | Ex. 5 | Ex. 6 | Ex. 7 | Ex. 8 | Ex. 9 | Ex. 10 | Comp. Ex. 6 |
|---|---|---|---|---|---|---|---|---|
| Liquid cristal polyester (1) | | 100 | 100 | 100 | 100 | 100 | — | 100 |
| Liquid crystal polyester (2) | | — | — | — | — | — | 100 | — |
| Fibrous | Filler (4) | — | 23.2 | 66.7 | 106.2 | 133.3 | 66.7 | — |
| filler | Filler (7) | 66.7 | — | — | — | — | — | — |
| | Filler (9) | — | — | — | — | — | — | 66.7 |

| | | | | | | | |
|---|---|---|---|---|---|---|---|
| Number average fiber length of | 59 | 32 | 27 | 29 | 27 | 28 | 58 |
| fibrous fillers (μm) | | | | | | | |
| Number average fiber diameter | 6 | 11 | 11 | 11 | 11 | 11 | 13 |
| of fibrous fillers (μm) | | | | | | | |
| Content of long fibers (%) | 22 | 0 | 0 | 0 | 0 | 0 | 18 |
| Izod impact strength (J/m) | 469 | 1030 | 617 | 612 | 483 | 276 | 449 |
| Surface roughness Sa after | 0.55 | 0.54 | 0.49 | 0.47 | 0.51 | 0.50 | 0.68 |
| tape peeling test (μm) | | | | | | | |

As shown in Tables 1 and 3, the resin molded bodies obtained by molding the liquid crystal polyester compositions of Examples 1 to 10 to which the present invention was applied had smaller values of the surface roughness Sa after the tape peeling test, as compared with the resin molded bodies obtained by molding the liquid crystal polyester compositions of Comparative Examples 1 to 6. Therefore, in the resin molded bodies of Examples 1 to 10, it is presumed that the fibrous fillers hardly fall off and the generation of foreign substances is suppressed. Further, among the examples to which the present invention was applied, the resin molded bodies of Examples 1 to 3 in which the number average fiber diameters of the fibrous fillers were 5 μm or less had higher Izod strength values than those of Comparative Examples 2, Comparative Example 4 and Comparative Example 5 in which the filling amount of the fibrous fillers was the same.

From the above results, it was shown that the present invention is useful.

### INDUSTRIAL APPLICABILITY

According to the present invention, since a liquid crystal polyester composition and a resin molded body in which the generation of foreign substances is suppressed can be provided, the present invention is extremely useful industrially.

1. A liquid crystal polyester composition comprising a liquid crystal polyester and fibrous fillers,
wherein in the fibrous fillers, the number of long fibers having a fiber length of 80 μm or more contained in the fibrous fillers is 30% or less with respect to the number of the fibrous fillers, and
a number average fiber diameter of the fibrous fillers is 12 μm or less.

2. A liquid crystal polyester composition comprising a liquid crystal polyester and fibrous fillers,
wherein a number average fiber length of the fibrous fillers is 15 μm or more and 60 μm or less, and
a number average fiber diameter of the fibrous fillers is 12 μm or less.

3. The liquid crystal polyester composition according to claim 1, wherein the number average fiber diameter of the fibrous fillers is 6 μm or less.

4. The liquid crystal polyester composition according to claim 1, wherein a content of the fibrous fillers is 10 parts by mass or more and 150 parts by mass or less with respect to 100 parts by mass of the liquid crystal polyester.

5. A resin molded body formed from the liquid crystal polyester composition according to claim 1.

6. The liquid crystal polyester composition according to claim 2, wherein the number average fiber diameter of the fibrous fillers is 6 μm or less.

7. The liquid crystal polyester composition according to claim 2, wherein a content of the fibrous fillers is 10 parts by mass or more and 150 parts by mass or less with respect to 100 parts by mass of the liquid crystal polyester.

8. A resin molded body formed from the liquid crystal polyester composition according to claim 2.
